(19) United States
(12) Patent Application Publication
(10) Pub. No.: US 2009/0194082 A1
(43) Pub. Date: Aug. 6, 2009

(54) TRANSISTOR TYPE IGNITION APPARATUS FOR INTERNAL COMBUSTION ENGINE

(75) Inventors: Yoichi YAMAMURA, Saitama (JP); Motohiro SHIMIZU, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 12/364,650

(22) Filed: Feb. 3, 2009

(30) Foreign Application Priority Data
Feb. 6, 2008 (JP) 2008-026373

(51) Int. Cl. F02P 3/06

(52) U.S. Cl. 123/605

(57) ABSTRACT

The present invention provides a transistor type ignition apparatus suitable for a gas engine in which high voltage output can be obtained with low input electricity. The ignition apparatus includes an ignition coil 2 having a primary coil 21 connected to a battery 6 and a secondary coil 22 connected to a spark plug 4, and a control circuit 3 having a transistor 32 which controls on and off of current flowing through the primary coil 21. The ignition apparatus also includes a surge absorbing capacitor 5 which is connected in parallel to the primary coil 21 and in which electric charge is accumulated by induced voltage of the primary coil 21. Electric charge is accumulated in the surge absorbing capacitor 5 by induced voltage of the primary coil 21. High secondary voltage is induced in the secondary coil 22 by discharge of the electric charge.

### BACKGROUND OF THE INVENTION

1. Field of the Invention

The present invention relates to a transistor type ignition apparatus for an internal combustion engine, and more particularly, to a transistor type ignition apparatus suitable for obtaining high output voltage with low input electricity.

2. Description of the Related Art

There is conventionally known a CDI ignition apparatus and a transistor type ignition apparatus as an ignition apparatus for an internal combustion engine. Japanese Patent Application Laid-open (JP-A) No.10-9111 describes an example of the CDI ignition apparatus. JP-A No.10-54332 describes the transistor type ignition apparatus. The CDI ignition apparatus and the transistor type ignition apparatus have advantages and drawbacks and they are used properly. In gas engines used for cogeneration apparatuses, the transistor type ignition apparatuses are employed in many cases.

Generally, in a cogeneration apparatus in which a gas engine which is the internal combustion engine is used, it is desired to reduce ignition spark energy and to increase a maintenance cycle so that a spark plug is not worn. In a gas engine, in order to ignite compression gas, high voltage of about 1.5 times of voltage for a gasoline engine is required as output voltage of the ignition apparatus.

As a method for obtaining such high voltage, it is conceived to use the CDI ignition apparatus, and to use an ignition coil having low coupling degree between a primary side and a secondary side. In the case of the CDI ignition apparatus, however, if a general DC low voltage is used as a power source in an engine auxiliary machine, since the number of circuit constituent elements is increased, size of a substrate for supporting the elements and electromagnetic noise are increased and cost is increased.

To solve this problem, it is conceived that an ignition coil having a low coupling degree is used in the transistor type ignition apparatus having a simple circuit structure, but in the transistor type ignition apparatus, since sustained time period of induced voltage is short, there is a problem that sufficient induced voltage can not be transmitted to the secondary side, and high output voltage can not be obtained.

The present invention has been accomplished to solve the above problem, and it is an object of the present invention to provide a transistor type ignition apparatus for an internal combustion engine capable of obtaining high output voltage by low input electricity.

### SUMMARY OF THE INVENTION

The present invention is characterized in that a transistor type ignition apparatus for an engine includes a surge absorbing capacitor which is connected in parallel to a primary coil of an ignition coil, and electric charge is accumulated in the surge absorbing capacitor by induced voltage of the primary coil.

According to the present invention having the above feature, electric charge is accumulated in the surge absorbing capacitor by induced voltage generated in the primary coil when current flowing in the primary coil is cut. When the capacitor voltage by the accumulated electric charge exceeds the induced voltage of the primary coil, induced voltage is generated by electric discharge from the surge absorbing capacitor. The induced voltage caused by discharge of the surge absorbing capacitor has smaller current variation speed as compared with induced voltage by the current cutoff of the primary coil. Therefore, even when an ignition coil having low coupling degree is used, high voltage output can be obtained.

According to the present invention, without using a CDI ignition apparatus which may increase the substrate size, electromagnetic noise and cost, high voltage output can be obtained without increasing the input electricity by the transistor type ignition apparatus. Since the high output voltage can be obtained without increasing the input electricity, power savings can be expected.

Further, high induced voltage can be suppressed by the surge absorbing capacitor, and there is also an effect that constituent parts having low voltage-resisting performance can be used.

### BRIEF DESCRIPTION OF THE DRAWINGS

FIG. 1 is a system block diagram of a transistor type ignition apparatus according to an embodiment of the present invention.

### DETAILED DESCRIPTION OF THE PREFERRED EMBODIMENTS

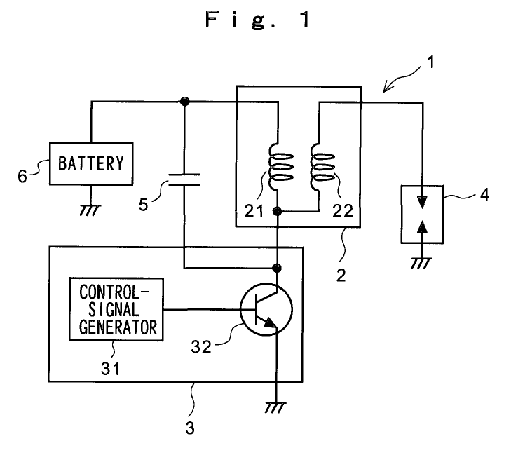

The present invention will be explained in detail with reference to the drawing. FIG. 1 is a system block diagram of the transistor type ignition apparatus according to an embodiment of the present invention. The transistor type ignition apparatus (simply “ignition apparatus”, hereinafter) 1 is applied to a gas engine, for example, is used for a cogeneration apparatus. The ignition apparatus 1 includes an ignition coil 2, a control circuit 3, a spark plug 4 and a capacitor (surge absorbing capacitor) 5. A battery 6 is connected to the ignition apparatus 1, and the battery 6 applies DC voltage of 12 to 15 volts to the ignition apparatus 1.

The ignition coil 2 includes a primary coil 21 connected to a plus side of the battery 6, and a secondary coil 22 connected to a plus side of the spark plug 4. The surge absorbing capacitor 5 is disposed in parallel to the primary coil 21. Therefore, the plus side of the battery 6 is also connected to the surge absorbing capacitor 5.

The control circuit 3 includes a control signal generator 31 and a transistor 32. A collector of the transistor 32 is connected to a minus side of the surge absorbing capacitor 5 and minus sides of the primary coil 21 and the secondary coil 22. An emitter of the transistor 32 is grounded.

The control signal generator 31 has a function for determining ignition timing based on a detection signal from an engine rotation angle detection sensor (not shown), and inputting an ignition control signal to a base of the transistor 32. The function of the control signal generator 31 is well known, and can be realized by a CPU.

The operation of the ignition apparatus 1 having the above-described structure will be explained. In a state where the transistor 32 is ON, i.e., in a state where current is supplied to the primary coil 21 from the battery 6, if an ignition control signal is input and the transistor 32 is turned OFF, current flowing through the primary coil 21 is cut off, and induced voltage is generated in the primary coil 21. The induced voltage E1 is calculated by the following equation 1.

$${E}_{1} = ( t ) \\ = {L}_{1} \frac{{I}_{1} ( t )}{{t}_{Tr}} \qquad Equation 1$$

In the equation 1, E1 represents primary coil induced voltage, L1 represents primary coil reactance, I1 represents current flowing through the primary coil 21, and tTr represents current cut-off time.

The induced voltage E1 generates secondary voltage (output voltage) in the secondary coil 22, charging current flows through the surge absorbing capacitor 5 by the induced voltage, and the surge absorbing capacitor 5 accumulates electric charge by the charging current. The charging current is determined by inductance of the primary coil 21, coil resistance and capacity of the surge absorbing capacitor 5. The electric charge Qc accumulated in the surge absorbing capacitor 5 is calculated by the following equation 2.

$${Q}_{c} = \int {i}_{c} ( t ) d t \\ = \int \frac{{E}_{1} ( t )}{{R}_{L 1}} d t \qquad Equation 2$$

In the equation 2, a symbol iC represents charging current, and a symbol RL1 represents resistance of the primary coil 21.

If the capacitor voltage of the surge absorbing capacitor 5 exceeds the induced voltage after cutting off the current, current caused by the capacitor voltage flows through the primary coil and output voltage is generated in the secondary coil 22. That is, subsequent to the induced voltage induced by the cut off of current, secondary voltage is induced in the primary coil 21 by the induced voltage caused by discharge of the surge absorbing capacitor 5.

This operation is compared with the conventional technique in which the surge absorbing capacitor 5 is not provided. When the surge absorbing capacitor 5 is not provided, since the sustained time period of induced voltage is short, induced voltage of the primary coil 21 can not sufficiently be converted into output voltage of the secondary coil 22.

If the surge absorbing capacitor 5 is provided as in the embodiment, since the surge absorbing capacitor 5 generates induced voltage in the primary coil 21 in accordance with a time constant determined by the coil resistance and capacitor capacity, the induced voltage generated in the primary coil 21 can converted into the output voltage effectively. Especially, the induced voltage caused by capacitor discharge has s smaller variation speed of current as compared with induced voltage caused by cutting off current and thus, even when an ignition coil having low coupling degree is used, high output voltage can be obtained. According to an experiment conducted by the present inventors, if the surge absorbing capacitor 5 was provided, output voltage could be enhanced by about 20% as compared with a case where the surge absorbing capacitor 5 is not provided.

By providing the surge absorbing capacitor 5, a voltage-resisting performance of the circuit constituent parts of the ignition apparatus can be reduced. In the transistor type ignition apparatus, high induced voltage (e.g., 550 volts) is generated in the primary coil when current is cut off. Therefore, it is necessary that the circuit constituent parts can withstand voltage which is equal to or higher than the induced voltage. However, since the induced voltage when current is cut off can be suppressed to about 450 volts by employing the surge absorbing capacitor 5, the voltage-resisting performance of the circuit constituent parts can be reduced.

According to the embodiment, the high voltage as high as the CDI ignition apparatus can be obtained with low input electricity by the transistor type ignition apparatus. Therefore, it is possible to provide an ignition apparatus suitable for a gas engine in which required voltage output performance is higher than that of a gasoline engine.

What is claimed is:

1. A transistor type ignition apparatus for an internal combustion engine comprising an ignition coil including a primary coil connected to a power source and a secondary coil connected to a spark plug, and a control circuit having a transistor which controls on and off of current flowing through the primary coil, wherein
a surge absorbing capacitor is connected in parallel to the primary coil, and electric charge is accumulated in the surge absorbing capacitor by induced voltage of the primary coil.
